(19) United States
(12) Patent Application Publication
(10) Pub. No.: US 2026/0262002 A1
(43) Pub. Date: Sep. 3, 2026

(54) SIGNAL TRANSMISSION METHOD AND APPARATUS, AND DEVICE

(71) Applicant: Spreadtrum Semiconductor (Nanjing) Co., Ltd., Nanjing (CN)

(72) Inventor: Zhenzhu LEI, Nanjing (CN)

(73) Assignee: Spreadtrum Semiconductor (Nanjing) Co., Ltd., Nanjing (CN)

(21) Appl. No.: 18/876,062

(22) PCT Filed: Jun. 13, 2023
(86) PCT No.: PCT/CN2023/100039

§ 371 Date: Dec. 17, 2024

(30) Foreign Application Priority Data
Jun. 17, 2022 (CN) 202210688697.0

(51) Int. Cl. H04W 64/00; H04W 76/40

(52) U.S. Cl. CPC H04W 64/00; H04W 76/40

(57) ABSTRACT

Embodiments of the present application provide a signal transmission method and apparatus, and a device, where the method includes: a second terminal device sends measurement request information to a first terminal device; the first terminal device receives the measurement request information sent by the second terminal device; the first terminal device sends a positioning reference signal to the second terminal device based on the measurement request information, where the positioning reference signal is used to determine a location of the second terminal device.

### CROSS-REFERENCE TO RELATED APPLICATIONS

This application is a national stage of International Application No. PCT/CN2023/100039, filed on Jun. 13, 2023, which claims priority to Chinese patent application No. 202210688697.0 titled “SIGNAL TRANSMISSION METHOD AND APPARATUS, AND DEVICE” and filed with the China National Intellectual Property Administration on Jun. 17, 2022. The two applications are incorporated into this application by reference in their entireties.

### TECHNICAL FIELD

The embodiments of the present application relate to the field of communication technologies, and in particular to a signal transmission method and apparatus, and a device.

### BACKGROUND

Currently, a communication link between a terminal device (UE) and a network equipment supports the transmission of a relevant positioning reference signal. For example, in the downlink (DL), each network device is configured with a dedicated downlink positioning reference signal (PRS) resource, and the network device can send PRS to the terminal device through the PRS resource. In the uplink (UL), each terminal device is configured with a dedicated uplink sounding reference signal (SRS) resource, and the terminal device can send SRS to the network device through the SRS resource.

However, a sidelink (SL) between terminal devices does not support the transmission of the positioning reference signal currently. In the future, the sidelink between terminal devices will support PRS transmission. How the terminal device configures the transmission resource of the positioning reference signal, to realize the transmission of the positioning reference signal in the sidelink is a technical issue that needs to be solved urgently.

### SUMMARY

The present disclosure provides a signal transmission method and apparatus, and a device, which realize the configuration of reference signal transmission resources in the sidelink.

In a first aspect, the present disclosure provides a signal transmission method, applied to a first terminal device, including:
receiving measurement request information sent by a second terminal device;
sending, based on the measurement request information, a positioning reference signal to the second terminal device.

In a second aspect, the present disclosure provides a signal transmission method, applied to a second terminal device, including:
sending measurement request information to a first terminal device;
receiving a positioning reference signal corresponding to the measurement request information sent by the first terminal device, where the positioning reference signal is used to determine a location of the second terminal device.

In a third aspect, the present disclosure provides a signal transmission apparatus, applied to a first terminal device, including a receiving module and a sending module; where
the receiving module is configured to receive measurement request information sent by a second terminal device;
the sending module is configured to send, based on the measurement request information, a positioning reference signal to the second terminal device.

In a fourth aspect, the present disclosure provides a signal transmission apparatus, applied to a second terminal device, including a sending module and a receiving module; where
the sending module is configured to send measurement request information to a first terminal device;
the receiving module is configured to receive a positioning reference signal corresponding to the measurement request information sent by the first terminal device, where the positioning reference signal is used to determine a location of the second terminal device.

In a fifth aspect, the present disclosure provides a signal transmission device, including: a processor, and a memory communicatively connected to the processor;
where the memory stores a computer program;
the processor executes the computer program to implement the method according to any one of the first aspect.

In a sixth aspect, the present disclosure provides a signal transmission device, including: a processor, and a memory communicatively connected to the processor;
where the memory stores a computer program;
the processor executes the computer program to implement the method according to any one of the second aspect.

In a seventh aspect, the present disclosure provides a non-transitory computer-readable storage medium, where the computer-readable storage medium has a computer program stored thereon, and when the computer program is executed by a computer, the method according to any one of the first aspect is implemented.

In an eighth aspect, the present disclosure provides a non-transitory computer-readable storage medium, where the computer-readable storage medium has a computer program stored thereon, and when the computer program is executed by a computer, the method according to any one of the second aspect is implemented.

### BRIEF DESCRIPTION OF DRAWINGS

FIG. 1 is a schematic diagram of a resource pool provided by an embodiment of the present disclosure.

FIG. 2 is a schematic diagram of autonomous resource selection by a terminal device provided by an embodiment of the present disclosure.

FIG. 3A is a schematic diagram of a communication system architecture provided by an embodiment of the present disclosure.

FIG. 3B is a schematic diagram of another communication system architecture provided by an embodiment of the present disclosure.

FIG. 3C is a schematic diagram of still another communication system architecture provided by an embodiment of the present disclosure.

FIG. 4 is a configuration structure of a PRS resource provided by an embodiment of the present disclosure.

FIG. 5 is a schematic flowchart of a signal transmission method provided by an embodiment of the present disclosure.

FIG. 6 is a schematic diagram of the measurement gap provided by an embodiment of the present disclosure.

FIG. 7 is a schematic flowchart of another signal transmission method provided by an embodiment of the present disclosure.

FIG. 8 is a signal transmission apparatus provided by an embodiment of the present disclosure.

FIG. 9 is a signal transmission apparatus provided by an embodiment of the present disclosure.

FIG. 10 is a schematic diagram of a hardware structure of the signal transmission device provided by the present disclosure.

### DESCRIPTION OF EMBODIMENTS

Illustrative embodiments will be described in detail herein, examples of which are illustrated in the accompanying drawings. When the following description refers to the drawings, the same numbers in different drawings refer to the same or similar elements unless otherwise indicated. The implementations described in the following illustrative embodiments do not represent all implementations consistent with the present disclosure. Rather, they are merely examples of apparatus and methods consistent with aspects of the present disclosure as detailed in the appended claims.

It should be noted that, in this document, the terms “comprising”, “including” or any other variation thereof are intended to cover a non-exclusive inclusion, such that a process, method, item or apparatus, that includes a series of elements, includes not only those elements, but also other elements not expressly listed, or includes elements inherent to the process, method, item or apparatus. Without further limitation, an element defined by the statement “includes a . . . ” does not exclude the presence of additional identical elements in a process, method, item or apparatus that includes the element.

The present disclosure relates to mobile communication technologies. In order to facilitate understanding of the embodiments of the present disclosure, the relevant communication technologies involved in the present disclosure are first described in detail.

### 1) Resource Pool

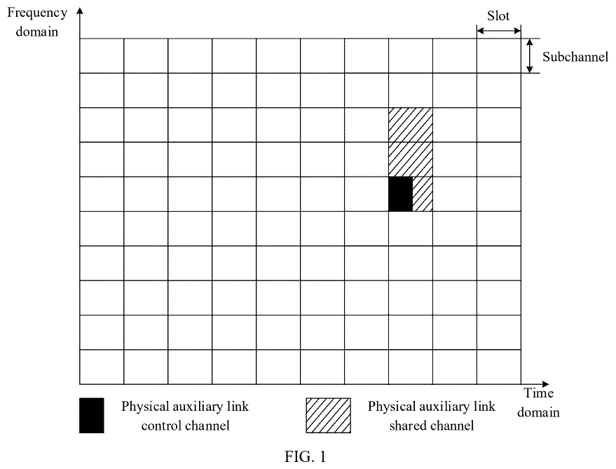

As shown in FIG. 1, FIG. 1 is a schematic diagram of a resource pool provided by an embodiment of the present disclosure. Please refer to FIG. 1, the granularity of time domain in the resource pool is slot, and the granularity of frequency domain is data transmission subchannel. Each data transmission subchannel includes m resource blocks (RB), and m is configured by the upper layer. When selecting a transmission resource, the terminal device can determine that L data transmission sub-channels are needed for transmission based on a size of a data packet, and can determine continuous L data transmission sub-channels as transmission resources on a certain slot in the resource pool. For example, FIG. 1 shows a transmission resource with L=3. Each transmission resource will transmit a physical sidelink control channel (PSCCH) and a physical sidelink share channel (PSSCH) at the same time. That is to say, each transmission will include PSCCH and PSSCH. PSCCH is used to carry sidelink control information (SCI). PSSCH is used to carry transmission data. The SCI may include time-frequency domain location information of a current transmission resource and time-frequency domain location information of a later reserved transmission resource, and may also include decoding some parameters in the PSSCH. In the transmission resource, the frequency domain starting position of PSCCH is the same as the frequency domain starting position of PSSCH. When the terminal device detects the PSCCH, it can obtain the frequency domain starting position of the current PSSCH.

### 2) Resource Allocation Mode 2a (Mode 2a)

In mode 2a, the terminal device can select a sidelink transmission resource in the resource pool based on a sensing resource selection method, without the need for the base station to participate in resource scheduling.

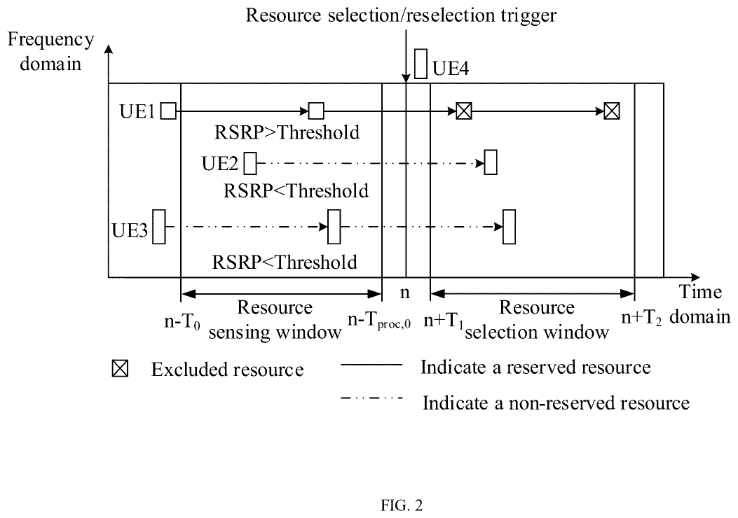

As shown in FIG. 2, FIG. 2 is a schematic diagram of autonomous resource selection by a terminal device provided by an embodiment of the present disclosure. Please refer to FIG. 2, UE4 triggers resource selection at time n, (n−T₀, n−T_{proc}, 0) is a resource sensing window, and (n+T₁, n+T₂) is a resource selection window. UE4 can perform resource sensing on the resource occupied by other terminal devices within the resource sensing window. At time n, when UE4 performs resource selection based on a sensing result in the resource sensing window, UE4 excludes a reserved resource of other terminal devices from the resources in the resource selection window, obtains a candidate resource set, and determines a target resource for transmitting data in the candidate resource set.

Specifically, UE4, which is performing resource sensing, detects the PSCCH of other terminal devices (e.g., UE1, UE2, UE3) in the resource sensing window. After detecting the PSCCH, UE4 can decode control information carried in the PSCCH and obtain resource indication information and resource reservation information of the corresponding terminal device from the control information. UE4 can also perform reference signal receiving power (Reference Signal Receiving Power, RSRP) measurement on the detected PSCCH, or UE4 can also perform RSRP measurement on a demodulation reference signal (Demodulation Reference Signal, DMRS) of the PSSCH corresponding to the detected PSCCH. If the RSRP measured by UE4 is higher than a preset threshold, the reserved resource of the corresponding terminal device is excluded.

Illustratively, please refer to FIG. 2, UE4 detects that RSRP of UE1 is higher than the preset threshold, and RSRP of UE2 and RSRP of UE3 is lower than the threshold. Therefore, UE4 excludes the reserved resource of UE1 from the resource in the resource selection window, and reserves the reserved resources of UE2 and UE3.
3) Unicast: refers to that a terminal device transmits data only to another terminal device.
4) Multicast: refers to that a terminal device transmits data to other terminal devices in the same group as the terminal device. In other words, multicast data can only be received by the terminal devices in the group, and the higher layer will indicate which terminal devices belong to a group.
5) Broadcast: refers to that a terminal device transmits data to all other terminal devices, and all terminal devices can receive the broadcast data.

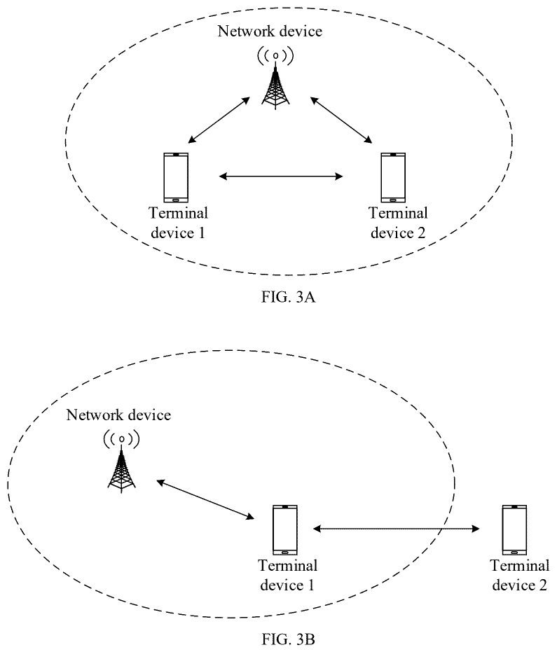

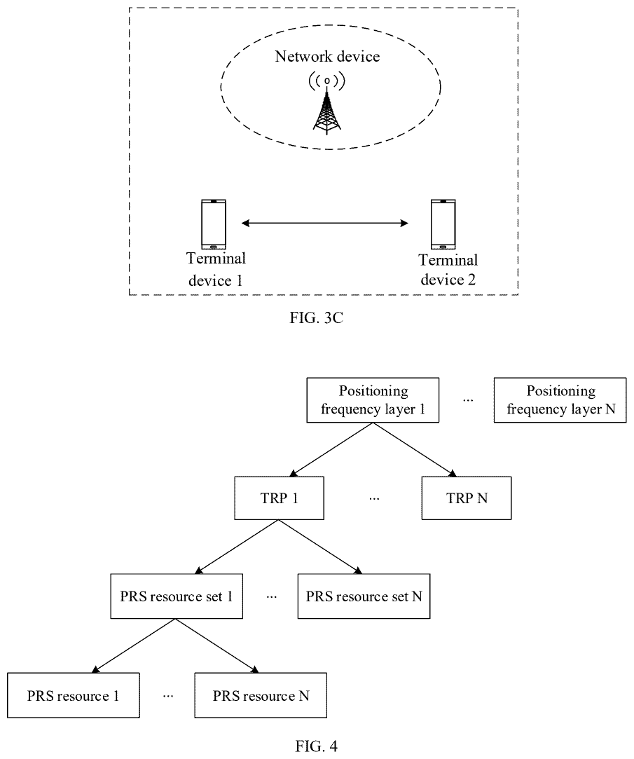

For ease of understanding, a communication system architecture involved in the embodiment of the present disclosure will be described below with reference to FIGS. 3A-3C.

FIG. 3A is a schematic diagram of a communication system architecture provided by an embodiment of the present disclosure. As shown in FIG. 3A, the communication system includes: a network device, terminal device 1 and terminal device 2.

In the above communication system architecture, both the terminal device 1 and the terminal device 2 are within the coverage of the network device. The terminal device 1 can communicate with the network device. The terminal device 2 can communicate with the network device. Communication between the terminal device 1 and the terminal device 2 is also possible.

FIG. 3B is a schematic diagram of another communication system architecture provided by an embodiment of the present disclosure. As shown in FIG. 3B, the communication system includes: a network device, terminal device 1 and terminal device 2.

In the above communication system architecture, the terminal device 1 is within the coverage of the network device. The terminal device 1 can communicate with the network device. The terminal device 2 is not within the coverage of the network device. The terminal device 1 can communicate with the terminal device 2.

FIG. 3C is a schematic diagram of still another communication system architecture provided by an embodiment of the present disclosure. As shown in FIG. 3C, the communication system includes: a network device, terminal device 1 and terminal device 2.

In the above communication system architecture, both the terminal device 1 and the terminal device 2 are not within the coverage of the network device. The terminal device 2 can communicate with the terminal device 1.

In the communication system architecture described above in FIGS. 3A-3C, the terminal device can be a vehicle, a vehicle-mounted terminal or a vehicle-mounted apparatus, a user terminal, a mobile device or a remote terminal, or a roadside device, etc. It should be understood that the number of network devices, terminal devices 1 and terminal devices 2 may be one or more, which is not limited in the embodiment of the present disclosure.

It should be noted that the system architecture described in the embodiment of the present disclosure are intended to illustrate the technical solution of the embodiments of the present disclosure more clearly and does not constitute a limitation to the technical solutions provided by the embodiments of the present disclosure. It is known to those skilled in the art that, with evolution of the network architecture and emergence of new business scenarios, the technical solutions provided by the embodiments of the present disclosure are equally applicable to similar problems.

In related technologies, positioning reference signals can be transmitted between the network device and the terminal device within the network device's coverage. When transmitting the positioning reference signal, the network device is configured with a dedicated positioning reference signal transmission resource, or the terminal device is configured with a dedicated positioning reference signal transmission resource. The positioning reference signal transmission resource is used to transmit the positioning reference signal. For example, for PRS, the network device is configured with a dedicated PRS resource, and the PRS resource is used to transmit PRS. For SRS, the terminal device is configured with a dedicated SRS resource, and the SRS resource is used to transmit SRS.

Next, taking PRS as an example, a configuration structure of a PRS resource will be described with reference to FIG. 4.

FIG. 4 is a configuration structure of a PRS resource provided by an embodiment of the present disclosure. Referring to FIG. 4, a positioning frequency layer can include a plurality of transmit receive points (TRPs), for example, TRP1, TRP2 . . . TRPN. TRP can be a network device. A TRP can correspond to a plurality of PRS resource sets, for example, PRS resource set 1, PRS resource set 2 . . . PRS resource set N. A PRS resource set may include a plurality of PRS resources, for example, PRS resource 1, PRS resource 2 . . . PRS resource N. For any TRP, the TRP can send PRS to the terminal device through the PRS resource configured by itself.

However, in the sidelink, the transmission of the positioning reference signal is not supported between terminal devices, and the transmission resource in the sidelink is relatively tight, making it difficult to configure a dedicated positioning reference signal transmission resource for each terminal device. When the terminal device is not within the coverage of the network device, the terminal device cannot perform positioning.

In order to solve the above technical problem, in the embodiment of the present application, the terminal device can determine the reference signal transmission resource in the resource pool in a resource sensing manner, to realize the transmission of the positioning reference signal in the sidelink. Through the above method, a terminal device can send a positioning reference signal to another terminal device to assist the another terminal device in positioning.

Below, the technical solutions shown in the present disclosure will be described through specific embodiments. It should be noted that the following embodiments can exist independently or can be combined with each other, and the same or similar content will not be repeatedly described in different embodiments.

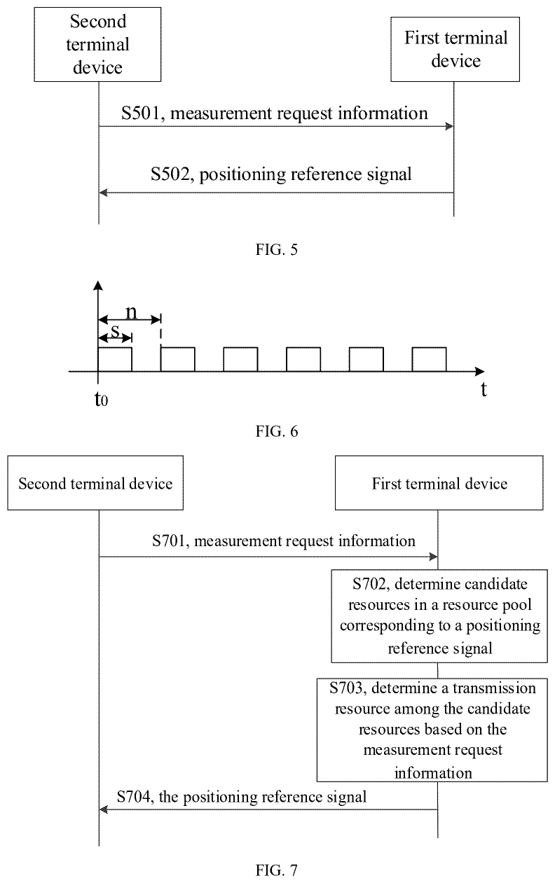

FIG. 5 is a schematic flowchart of a signal transmission method provided by an embodiment of the present disclosure. As shown in FIG. 5, the method of this embodiment includes:

S501, a second terminal device sends measurement request information to a first terminal device.

Correspondingly, the first terminal device receives the measurement request information sent by the second terminal device.

The second terminal device may be a terminal device with a positioning requirement.

The first terminal device may be a terminal device that assists the second terminal device in positioning.

In this embodiment of the present disclosure, the second terminal device can generate measurement request information according to its own positioning requirement and resource reservation condition, and can send the measurement request information to the first terminal device.

It should be noted that, the second terminal device can use a resource in the resource pool corresponding to the data transmission to send the measurement request information to the first terminal device.

The measurement request information may trigger the first terminal device to send a positioning reference signal to the second terminal device. The second terminal device receives the positioning reference signal to perform positioning measurement, and determines the location of the second terminal based on the measurement result.

The measurement request information may include a measurement slot used by the second terminal device for measurement. Specifically, the measurement request information includes at least one of the following: a starting time domain position of a measurement slot; a period of a measurement slot; or duration of a measurement slot.

The measurement slot may be a time period used by the second terminal device to receive the positioning reference signal. The measurement slot occurs periodically in the time domain.

The starting time domain position of the measurement slot may be the time domain starting position of the first measurement slot.

The duration of the measurement slot may be duration of the time period during which the second terminal device receives the positioning reference signal.

The period of the measurement slot may be a time interval between the starting time domain positions of two consecutive measurement slots.

Next, with reference to FIG. 6, the starting time domain position of the measurement slot, the period of the measurement slot, and the duration of the measurement slot will be described.

FIG. 6 is a schematic diagram of the measurement gap provided by an embodiment of the present disclosure. Refer to FIG. 6, the starting time domain position of the measurement slot of the second terminal device is to; to can be a slot number, a subframe number, or an absolute time. The duration of the measurement slot for the second terminal device to receive the positioning reference signal is s, and the period of the measurement slot for the second terminal device is n; where units of s and n may be ms, slot, subframe, etc.

In the embodiment of the present application, the second terminal device may send the measurement request information to the first terminal device in a unicast, multicast or broadcast mode.

When the second terminal device sends measurement request information to the first terminal device in unicast mode, the second terminal device only sends the measurement request information to the first terminal device; when the second terminal device sends measurement request information to the first terminal device in multicast mode, the second terminal device sends measurement request information to the first terminal device, and the second terminal device can also send the measurement request information to other terminal devices in the same group as the second terminal device at the same time; when the second terminal device sends measurement request information to the first terminal device in broadcast mode, the second terminal device sends measurement information to the first terminal device, and can also send the measurement request information to all other terminal devices at the same time.

It should be understood that when selecting and/or reserving the data transmission resource, the second terminal device needs to exclude the resource that overlaps with the measurement slot.

S502, the first terminal device sends a positioning reference signal to the second terminal device based on the measurement request information.

Correspondingly, the second terminal device receives the positioning reference signal sent by the first terminal device.

The first terminal device may send a positioning reference signal to the second terminal device during the measurement slot based on the measurement request information, to assist the second terminal device in positioning.

In this embodiment, the second terminal device can generate measurement request information according to its own positioning requirement and resource reservation condition, and can send the measurement request information to the first terminal device. The first terminal device may send a positioning reference signal to the second terminal device during the measurement slot of the second terminal device according to the measurement request information, to assist the second terminal device in positioning. Through the above method, the transmission of the positioning reference signal in the sidelink can be achieved.

Based on the above embodiment, when the first terminal device sends a positioning reference signal to the second terminal device, it needs to determine the positioning reference signal transmission resource. Next, with reference to FIG. 7, the method for the first terminal device to determine the positioning reference signal transmission resource during the positioning reference signal transmission process will be described.

FIG. 7 is a schematic flowchart of another signal transmission method provided by an embodiment of the present disclosure. As shown in FIG. 7, the method of this embodiment includes:

S701, a second terminal device sends measurement request information to a first terminal device.

In this embodiment, the specific implementation of S701 can be referred to the detailed description of S501, which will not be described repeatedly here.

S702, the first terminal device determines a candidate resource in a resource pool corresponding to the positioning reference signal.

The resource pool corresponding to the positioning reference signal is the resource pool where the resource used to transmit the positioning reference signal is located. In the embodiment of the present disclosure, the resource pool corresponding to the positioning reference signal is the same as a resource pool corresponding to data transmission; or, the resource pool corresponding to the positioning reference signal is different from the resource pool corresponding to data transmission.

In a possible implementation, the resource pool corresponding to the positioning reference signal is the same as a resource pool corresponding to data transmission. At this time, the positioning reference signal and data share a transmission resource pool, and the first terminal device can determine the candidate resource in the resource pool corresponding to data transmission.

In another possible implementation, the resource pool corresponding to the positioning reference signal is different from the resource pool corresponding to data transmission. At this time, the positioning reference signal is configured with a dedicated resource pool, and the first terminal device can determine the candidate resource in a resource pool dedicated to the positioning reference signal.

It should be understood that when the positioning reference signal is configured with a dedicated resource pool, the resource pool corresponding to the positioning reference signal may be at a different frequency from the resource pool corresponding to data transmission; or, the resource pool corresponding to the positioning reference signal may be on a different carrier channel from the resource pool corresponding to the data transmission; or, the resource pool corresponding to the positioning reference signal can be on a different bandwidth part (Bandwidth Part, BWP) from the resource pool corresponding to data transmission.

When the resource pool corresponding to the positioning reference signal and the resource pool corresponding to the data transmission are at different frequency points, the first terminal device needs to readjust the radio frequency link. That is, the frequency point for current data transmission is readjusted to the frequency point for positioning reference signal transmission, and the determination of the candidate resource is performed.

When the resource pool corresponding to the positioning reference signal and the resource pool corresponding to data transmission are on different carrier channels, the first terminal device needs to perform carrier switching. That is, the carrier for current data transmission is switched to the carrier for positioning reference signal transmission, and the determination of the candidate resource is performed.

When the resource pool corresponding to the positioning reference signal and the resource pool corresponding to data transmission are on different BWPs, the first terminal device needs to perform BWP switching. That is, the BWP for current data transmission is switched to the BWP for positioning reference signal transmission, and the determination of the candidate resource is performed.

The candidate resources is a set of periodically available resources. When determining the candidate resource, the first terminal device determines an unoccupied resource in the resource pool corresponding to the positioning reference signal based on a resource sensing result in a resource sensing window of a resource pool corresponding to the positioning reference signal; and determines the candidate resource based on the unoccupied resource. Specifically, the first terminal device periodically reserves based on the unoccupied resource to obtain the candidate resource.

The unoccupied resource is an available resource in the resource pool. After the first terminal device excludes an occupied resource from the resource pool based on the sensing result in the resource sensing window, the remaining resources in the resource pool are unoccupied resources.

S703, the first terminal device determines the transmission resource among the candidate resource based on the measurement request information.

The transmission resource is a resource used by the first terminal device to transmit the positioning reference signal.

In the embodiment of the present disclosure, based on the number of the second terminal devices, determination of the transmission resource among the candidate resources includes at least the following two cases:

Case 1: the number of the second terminal devices is 1. That is, the first terminal device receives the measurement request information from the second terminal device.

In this case, the first terminal device determines a target resource among the candidate resources, and the measurement slot of the target resource overlaps with the measurement slot of the second terminal device; when a ratio of the number of target resources to a total number of candidate resources is greater than or equal to a preset threshold, the target resource is determined as the transmission resource, and the first terminal device uses the determined transmission resource to send the positioning reference signal to the second terminal device.

The target resource is the candidate resource that overlaps with the measurement slot.

Specifically, when the ratio of the number of candidate resources that overlap with the measurement slot to the total number of candidate resources is greater than or equal to a preset threshold, the above-mentioned candidate resource that overlaps with the measurement gap is determined as the transmission resource.

Illustratively, it is assumed that the candidate resource determined by the first terminal device are 10 resources that appear periodically and the preset threshold is 80%. Then, when 8 or more candidate resources overlap with the measurement slot, the 8 candidate resources that overlap with the measurement slot are determined as the transmission resources.

Case 2: the number of the second terminal devices is M. That is, the first terminal device receives the measurement request information from M second terminal devices. M is an integer greater than or equal to 2.

In this case, the target resource corresponding to each second terminal device is determined among the candidate resource, and the target resource overlaps with the measurement slot corresponding to the second terminal device; based on the number of the target resources corresponding to each second terminal device, N target terminal devices are determined among M second terminal devices, where a ratio of the number of the target resources corresponding to the target terminal device to a total number of the candidate resources is greater than or equal to a first threshold; if a ratio of N to M is greater than or equal to a second threshold, based on the target resources corresponding to the N target terminal devices, the transmission resources are determined, and the first terminal device uses the determined transmission resource to send the positioning reference signal to the second terminal device.

For any second terminal device, the target resource is a candidate resource that overlaps with the measurement slot of the second terminal device.

For any second terminal device, when the ratio of the number of target resources of the second terminal device to the total number of candidate resources is greater than or equal to the first threshold, the second terminal device is determined as the target terminal device. For example, assuming that the first threshold is 80%, when the ratio of the number of target resources of a certain second terminal device to the total number of candidate resources is greater than or equal to 80%, the second terminal device is determined to be the target terminal device.

For M second terminal devices, when the ratio of the total number of the target terminal devices N to M is greater than or equal to the second threshold, the transmission resource is determined based on the target resources corresponding to the N target terminal devices. For example, assuming that the second threshold is 60% and M is 8, when N is greater than or equal to 5, the first terminal device can determine the transmission resource based on the target resources of the 5 target terminal devices.

Specifically, the first terminal device determines an intersection of the target resources corresponding to the N target terminal devices as the transmission resource; or determines a union of target resources corresponding to the N target terminal devices as the transmission resource.

Illustratively, assume that M is 8, the number of candidate resources is 10, the first threshold is 80%, and the second threshold is 60%. Then, the first terminal device can determine the transmission resource through at least the following steps:
1) Determine the target resources of the 8 second terminal devices respectively.
2) When the number of the target resources is greater than or equal to 8 (10*80%=8), the second terminal device corresponding to the target resource is recorded as the target terminal device.
3) When the number of target terminal devices is greater than or equal to 5 (┌8*60%┐=5), determine the transmission resource to be the union of target resources of all target terminal devices, or determine the transmission resource to be the intersection of the target resources of all target terminal devices.

S704, the first terminal device sends a positioning reference signal to the second terminal device on the transmission resource.

Correspondingly, the second terminal device acquires the positioning reference signal from the first terminal device.

When the resource pool corresponding to the positioning reference signal and the resource pool corresponding to the data transmission are the same resource pool, the second terminal device can receive the positioning reference signal through the resource in the resource pool corresponding to the data transmission. When the resource pool corresponding to the positioning reference signal and the resource pool corresponding to data transmission are different resource pools, the second terminal device may receive the positioning reference signal through the resource in the resource pool corresponding to the positioning reference signal.

It should be understood that when the resource pool corresponding to the positioning reference signal and the resource pool corresponding to the data transmission are at different frequency points, the second terminal device needs to readjust the radio frequency link. That is, the frequency point for current data transmission is readjusted to the frequency point of positioning reference signal transmission, and the reception of the positioning reference signal is completed in the measurement slot.

When the resource pool corresponding to the positioning reference signal and the resource pool corresponding to data transmission are on different carrier channels, the second terminal device needs to perform carrier switching. That is, the carrier for current data transmission is switched to the carrier for positioning reference signal transmission, and the reception of the positioning reference signal is completed in the measurement slot.

When the resource pool corresponding to the positioning reference signal and the resource pool corresponding to data transmission are on different BWPs, the second terminal device needs to perform BWP switching. That is, the BWP for current data transmission is switched to the BWP for the positioning reference signal transmission, and the reception of the positioning reference signal is completed in the measurement slot.

It should be noted that after the second terminal device sends the measurement request information to the first terminal device, the second terminal device can enable the measurement slot and receive the positioning reference signal in the measurement slot; or, after the second terminal device sends the measurement request information to the first terminal device, the second terminal device can delay k time units to enable the measurement slot and receive the positioning reference signal in the measurement slot. k is an integer greater than or equal to 1.

In this embodiment, the second terminal device may send the measurement request information to the first terminal device. The first terminal device may determine the transmission resource in the resource pool corresponding to the positioning reference signal based on the measurement request information, and send the positioning reference signal to the second terminal device on the transmission resource. Through the above method, the configuration of the positioning reference signal transmission resource in the sidelink can be realized, so that a terminal device can send a positioning reference signal to another terminal device to assist the another terminal device in positioning.

FIG. 8 is a signal transmission apparatus provided by an embodiment of the present disclosure. Please refer to FIG. 8, the signal transmission apparatus 800 can be applied to the first terminal device. The signal transmission apparatus 800 includes a receiving module 801 and a sending module 802; where,
the receiving module 801 is configured to receive measurement request information sent by a second terminal device;
the sending module 802 is configured to send, based on the measurement request information, a positioning reference signal to the second terminal device.

The signal transmission apparatus 800 may be a chip, a chip module, etc.

The signal transmission apparatus provided by the embodiments of the present application can implement the solutions shown in the above method embodiments, and the implementation principles and beneficial effects, which will not be repeated here.

In a possible implementation, the measurement request information includes at least one of the following:
a starting time domain position of a measurement slot;
a period of a measurement slot;
duration of a measurement slot.

In a possible implementation, the sending module 802 is specifically configured to:
determine, based on the measurement request information, a transmission resource;
send the positioning reference signal to the second terminal device on the transmission resource.

In a possible implementation, the sending module 802 is specifically configured to:
determine a candidate resource in a resource pool corresponding to the positioning reference signal;
determine, based on the measurement request information, the transmission resource among the candidate resource.

In a possible implementation, the sending module 802 is specifically configured to:
determine, based on a resource sensing result in a resource sensing window of a resource pool corresponding to the positioning reference signal, an unoccupied resource in resource pool corresponding to the positioning reference signal;
determine, based on the unoccupied resource, the candidate resource.

In a possible implementation, the resource pool corresponding to the positioning reference signal is the same as a resource pool corresponding to data transmission; or, the resource pool corresponding to the positioning reference signal is different from the resource pool corresponding to data transmission.

In a possible implementation, the sending module 802 is specifically configured to:
determine a target resource among the candidate resource, where the target resource overlaps with the measurement slot;
when a ratio of the number of target resources to a total number of candidate resources is greater than or equal to a preset threshold, determine the target resource as the transmission resource.

In a possible implementation, the number of the second terminal devices is M, and the sending module 802 is specifically configured to:
determine a target resource corresponding to each second terminal device among the candidate resource, where the target resource overlaps with the measurement slot corresponding to the second terminal device;
determine, based on the number of the target resources corresponding to each second terminal device, N target terminal devices among M second terminal devices, where a ratio of the number of the target resources corresponding to the target terminal device to a total number of the candidate resources is greater than or equal to a first threshold;
if a ratio of the N to the M is greater than or equal to a second threshold, determine, based on target resources corresponding to the N target terminal devices, the transmission resource.

In a possible implementation, the sending module 802 is specifically configured to:
determine an intersection of target resources corresponding to the N target terminal devices as the transmission resource; or,
determine a union of target resources corresponding to the N target terminal devices as the transmission resource.

The signal transmission apparatus provided by the embodiments of the present application can implement the solutions shown in the above method embodiments, and the implementation principles and beneficial effects, which will not be repeated here.

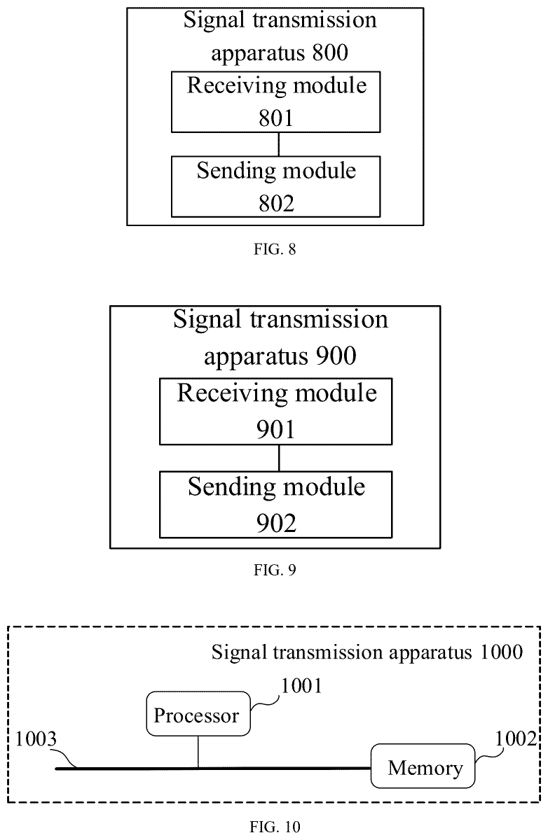

FIG. 9 is a signal transmission apparatus provided by an embodiment of the present disclosure. Please refer to FIG. 9, the signal transmission apparatus 900 can be applied to the second terminal device. The signal transmission apparatus 900 includes a sending module 901 and a receiving module 902; where,
the sending module 901 is configured to send measurement request information to a first terminal device;

the receiving module 902 is configured to receive a positioning reference signal corresponding to the measurement request information sent by the first terminal device, where the positioning reference signal is used to determine a location of the second terminal device.

The signal transmission apparatus 900 may be a chip, a chip module, etc.

The signal transmission apparatus provided by the embodiments of the present application can implement the solutions shown in the above method embodiments, and the implementation principles and beneficial effects, which will not be repeated here.

In a possible implementation, the measurement request information includes at least one of the following:
a starting time domain position of a measurement slot;
a period of a measurement slot;
duration of a measurement slot.

In a possible implementation, the sending module 901 is specifically configured to:
send the measurement request information to the first terminal device in a unicast, multicast or broadcast mode.

In a possible implementation, the receiving module 902 is specifically configured to:
receive the positioning reference signal through a resource in a resource pool corresponding to the positioning reference signal; or
receive the positioning reference signal through a resource in a resource pool corresponding to data transmission.

The signal transmission apparatus provided by the embodiments of the present application can implement the solutions shown in the above method embodiments, and the implementation principles and beneficial effects, which will not be repeated here.

FIG. 10 is a schematic diagram of a hardware structure of the signal transmission device provided by the present disclosure. Please refer to FIG. 10, the signal transmission device 1000 may include: a processor 1001 and a memory 1002, where the processor 1001 and the memory 1002 can communicate. Illustratively, the processor 1001 and the memory 1002 communicate through a communication bus 1003, the memory 1002 is configured to store program instructions, and the processor 1001 is configured to call the program instructions in the memory to execute the signal transmission method illustrated in any of the above method embodiments.

Optionally, the signal transmission device 1000 may also include a communication interface, and the communication interface may include a transmitter and/or a receiver.

Optionally, the above-mentioned processor can be a central processing unit (CPU), or other general-purpose processors, digital signal processors (DSP), application specific integrated circuit (ASIC), etc. A general-purpose processor may be a microprocessor, or the processor may be any conventional processor, etc. The steps of the method disclosed in conjunction with the application can be directly embodied as being executed by a hardware processor, or executed by a combination of hardware and software modules in the processor.

Embodiments of the present disclosure further provides a computer-readable storage medium, which has a computer program stored thereon, and when the computer program is executed by a computer, the signal transmission method executed by the first terminal device in any of the above method embodiments can be implemented, the implementation principles and technical effects thereof are similar, which will not be described in detail here.

Embodiments of the present disclosure further provide a computer-readable storage medium, which has a computer program stored thereon, and when the computer program is executed by a computer, the signal transmission method executed by the second terminal device in any of the above method embodiments can be implemented, the implementation principles and technical effects thereof are similar, which will not be described in detail here.

Embodiments of the present disclosure further provide a computer program product, including a computer program, and when the computer program is executed by a computer, the signal transmission method executed by the first terminal device in any of the above method embodiments can be implemented, the implementation principles and technical effects thereof are similar, which will not be described in detail here.

Embodiments of the present disclosure further provide a computer program product, including a computer program, and when the computer program is executed by a computer, the signal transmission method executed by the second terminal device in any of the above method embodiments can be implemented, the implementation principles and technical effects thereof are similar, which will not be described in detail here.

All or part of the steps to implement the above method embodiments can be completed by hardware related to program instructions. The aforementioned program can be stored in a readable memory. When the program is executed, the steps including the above method embodiments are executed; and the aforementioned memory (storage medium) includes: a read-only memory (ROM), a RAM, a flash memory, a hard disk, a solid state disk, a magnetic tape, a floppy disk, an optical disk and any combination thereof.

Embodiments of the present disclosure are described with reference to flowcharts and/or block diagrams of methods, devices (systems), and computer program products according to embodiments of the present disclosure. It will be understood that each process and/or block in the flowchart illustration and/or block diagram, and combinations of processes and/or blocks in the flowchart illustration and/or block diagram, can be implemented by computer program instructions. These computer program instructions may be provided to a processing unit of a general-purpose computer, a special-purpose computer, an embedded processor or other programmable terminal device to produce a machine, which causes instructions executed by the processing unit of a computer or other programmable terminal device produce an apparatus used to implement a function specified in a process or multiple processes in a flowchart and/or a block or multiple blocks in a block diagram.

These computer program instructions may also be stored in a computer-readable memory that causes a computer or other programmable terminal devices to operate in a particular manner, which causes the instructions stored in the computer-readable memory produce a manufacture that includes an instruction apparatus used to implement a function specified in a process or multiple processes in a flowchart and/or a block or multiple blocks in a block diagram.

These computer program instructions may also be loaded onto a computer or other programmable terminal devices, that causes a series of operating steps to be performed on the computer or other programmable devices to produce computer-implemented processing, thereby causing the instructions to be executed on the computer or other programmable devices provide steps for implementing a function specified in a process or multiple processes in a flowchart and/or a block or multiple blocks in a block diagram.

Obviously, those skilled in the art can make various changes and modifications to the embodiments of the present disclosure without departing from the spirit and scope of the present disclosure. In this way, if these modifications and variations of the embodiments of the present disclosure fall within the scope of the claims of this application and equivalent technologies, then this application is also intended to include these modifications and variations. In the present disclosure, the term “including” and its variations may refer to non-limiting inclusion; the term “or” and its variations may refer to “and/or”. The terms “first”, “second”, etc. in the present disclosure are used to distinguish similar objects and are not necessarily used to describe a particular order or sequence. In the preset disclosure, “a plurality of” means two or more. The “and/or” is an association relationship describing associated objects, and represents that there may be three relationships. For example, A and/or B may represent three situations: presence of A only, of both A and B, and of B only. The character “/” herein generally represents an “or” relationship between contextual objects.

In a first aspect, the present disclosure provides a signal transmission method, applied to a first terminal device, including:
receiving measurement request information sent by a second terminal device;
sending, based on the measurement request information, a positioning reference signal to the second terminal device.

In a possible implementation, the measurement request information includes at least one of the following:
a starting time domain position of a measurement slot;
a period of a measurement slot;
duration of a measurement slot.

In a possible implementation, the sending, based on the measurement request information, the positioning reference signal to the second terminal device includes:
determining, based on the measurement request information, a transmission resource;
sending the positioning reference signal to the second terminal device on the transmission resource.

In a possible implementation, the determining, based on the measurement request information, the transmission resource includes:
determining a candidate resource in a resource pool corresponding to the positioning reference signal;
determining, based on the measurement request information, the transmission resource among the candidate resource.

In a possible implementation, the determining the candidate resource in the resource pool corresponding to the positioning reference signal includes:
determining, based on a resource sensing result in a resource sensing window of a resource pool corresponding to the positioning reference signal, an unoccupied resource in the resource pool corresponding to the positioning reference signal;
determining, based on the unoccupied resource, the candidate resource.

In a possible implementation, the resource pool corresponding to the positioning reference signal is the same as a resource pool corresponding to data transmission; or, the resource pool corresponding to the positioning reference signal is different from the resource pool corresponding to data transmission.

In a possible implementation, the determining, based on the measurement request information, the transmission resource among the candidate resources includes:
determining a target resource among the candidate resource, where the target resource overlaps with the measurement slot;
when a ratio of the number of target resources to a total number of candidate resources is greater than or equal to a preset threshold, determining the target resource as the transmission resource.

In a possible implementation, the number of the second terminal devices is M; and the determining, based on the measurement request information, the transmission resource among the candidate resources includes:
determining a target resource corresponding to each second terminal device among the candidate resource, where the target resource overlaps with the measurement slot corresponding to the second terminal device;
determining, based on the number of the target resources corresponding to each second terminal device, N target terminal devices among M second terminal devices, where a ratio of the number of the target resources corresponding to the target terminal device to a total number of the candidate resources is greater than or equal to a first threshold;
if a ratio of the N to the M is greater than or equal to a second threshold, determining, based on target resources corresponding to the N target terminal devices, the transmission resource.

In a possible implementation, the determining, based on the target resources corresponding to the N target terminal devices, the transmission resource includes:
determining an intersection of target resources corresponding to the N target terminal devices as the transmission resource; or,
determining a union of target resources corresponding to the N target terminal devices as the transmission resource.

In a second aspect, the present disclosure provides a signal transmission method, applied to a second terminal device, including:
sending measurement request information to a first terminal device;
receiving a positioning reference signal corresponding to the measurement request information sent by the first terminal device, where the positioning reference signal is used to determine a location of the second terminal device.

In a possible implementation, the measurement request information includes at least one of the following:
a starting time domain position of a measurement slot;
a period of a measurement slot;
duration of a measurement slot.

In a possible implementation, the sending the measurement request information to the first terminal device includes:
sending the measurement request information to the first terminal device in a unicast, multicast or broadcast mode.

In a possible implementation, the receiving the positioning reference signal corresponding to the measurement request information sent by the first terminal device includes:
receiving the positioning reference signal through a resource in a resource pool corresponding to the positioning reference signal; or
receiving the positioning reference signal through a resource in a resource pool corresponding to data transmission.

In a third aspect, the present disclosure provides a signal transmission apparatus, applied to a first terminal device, including a receiving module and a sending module; where
the receiving module is configured to receive measurement request information sent by a second terminal device;
the sending module is configured to send, based on the measurement request information, a positioning reference signal to the second terminal device.

In a possible implementation, the measurement request information includes at least one of the following:
a starting time domain position of a measurement slot;
a period of a measurement slot;
duration of a measurement slot.

In a possible implementation, the sending module is specifically configured to:
determine, based on the measurement request information, a transmission resource;
send the positioning reference signal to the second terminal device on the transmission resource.

In a possible implementation, the sending module is specifically configured to:
determine a candidate resource in a resource pool corresponding to the positioning reference signal;
determine, based on the measurement request information, the transmission resource among the candidate resource.

In a possible implementation, the sending module is specifically configured to:
determine, based on a resource sensing result in a resource sensing window of a resource pool corresponding to the positioning reference signal, an unoccupied resource in resource pool corresponding to the positioning reference signal;
determine, based on the unoccupied resource, the candidate resource.

In a possible implementation, the resource pool corresponding to the positioning reference signal is the same as a resource pool corresponding to data transmission; or, the resource pool corresponding to the positioning reference signal is different from the resource pool corresponding to data transmission.

In a possible implementation, the sending module is specifically configured to:
determine a target resource among the candidate resource, where the target resource overlaps with the measurement slot;
when a ratio of the number of target resources to a total number of candidate resources is greater than or equal to a preset threshold, determine the target resource as the transmission resource.

In a possible implementation, the number of the second terminal devices is M, and the sending module is specifically configured to:
determine a target resource corresponding to each second terminal device among the candidate resource, where the target resource overlaps with the measurement slot corresponding to the second terminal device;
determine, based on the number of the target resources corresponding to each second terminal device, N target terminal devices among M second terminal devices, where a ratio of the number of the target resources corresponding to the target terminal device to a total number of the candidate resources is greater than or equal to a first threshold;
if a ratio of the N to the M is greater than or equal to a second threshold, determine, based on target resources corresponding to the N target terminal devices, the transmission resource.

In a possible implementation, the sending module is specifically configured to:
determine an intersection of target resources corresponding to the N target terminal devices as the transmission resource; or,
determine a union of target resources corresponding to the N target terminal devices as the transmission resource.

In a fourth aspect, the present disclosure provides a signal transmission apparatus, applied to a second terminal device, including a sending module and a receiving module; where
the sending module is configured to send measurement request information to a first terminal device;
the receiving module is configured to receive a positioning reference signal corresponding to the measurement request information sent by the first terminal device, where the positioning reference signal is used to determine a location of the second terminal device.

In a possible implementation, the measurement request information includes at least one of the following:
a starting time domain position of a measurement slot;
a period of a measurement slot;
duration of a measurement slot.

In a possible implementation, the sending module is specifically configured to:
send the measurement request information to the first terminal device in a unicast, multicast or broadcast mode.

In a possible implementation, the receiving module is specifically configured to:
receive the positioning reference signal through a resource in a resource pool corresponding to the positioning reference signal; or
receive the positioning reference signal through a resource in a resource pool corresponding to data transmission.

In a fifth aspect, the present disclosure provides a signal transmission device, including: a processor, and a memory communicatively connected to the processor;
where the memory stores a computer program;
the processor executes the computer program to implement the method according to any one of the first aspect.

In a sixth aspect, the present disclosure provides a signal transmission device, including: a processor, and a memory communicatively connected to the processor;
where the memory stores a computer program;
the processor executes the computer program to implement the method according to any one of the second aspect.

In a seventh aspect, the present disclosure provides a computer-readable storage medium, where the computer-readable storage medium has a computer program stored thereon, and when the computer program is executed by a computer, the method according to any one of the first aspect is implemented.

In an eighth aspect, the present disclosure provides a computer-readable storage medium, where the computer-readable storage medium has a computer program stored thereon, and when the computer program is executed by a computer, the method according to any one of the second aspect is implemented.

In a ninth aspect, the present disclosure provides a computer program product, including a computer program that, when executed by a computer, implements the method according to any one of the first aspect.

In a tenth aspect, the present application provides a computer program product, including a computer program that, when executed by a computer, implements the method according to any one of the second aspect.

According to the signal transmission method and apparatus, and the device provided by the present disclosure, the second terminal device can generate measurement request information according to its own positioning requirement and resource reservation condition, and can send the measurement request information to the first terminal device. The first terminal device may send a positioning reference signal to the second terminal device during the measurement slot of the second terminal device based on the measurement request information, to assist the second terminal device in positioning. Through the above method, the transmission of the positioning reference signal in the sidelink can be achieved.

1. A signal transmission method, applied to a first terminal device, comprising:
receiving measurement request information sent by a second terminal device;
sending, based on the measurement request information, a positioning reference signal to the second terminal device.

2. The method according to claim 1, wherein the measurement request information comprises at least one of:
a starting time domain position of a measurement slot;
a period of a measurement slot;
duration of a measurement slot.

3. The method according to claim 2, wherein the sending, based on the measurement request information, the positioning reference signal to the second terminal device comprises:
determining, based on the measurement request information, a transmission resource;
sending the positioning reference signal to the second terminal device on the transmission resource.

4. The method according to claim 3, wherein the determining, based on the measurement request information, the transmission resource comprises:
determining a candidate resource in a resource pool corresponding to the positioning reference signal;
determining, based on the measurement request information, the transmission resource among the candidate resource.

5. The method according to claim 4, wherein the determining the candidate resource in the resource pool corresponding to the positioning reference signal comprises:
determining, based on a resource sensing result in a resource sensing window of a resource pool corresponding to the positioning reference signal, an unoccupied resource in the resource pool corresponding to the positioning reference signal;
determining, based on the unoccupied resource, the candidate resource.

6. The method according to claim 5, wherein
the resource pool corresponding to the positioning reference signal is the same as a resource pool corresponding to data transmission; or,
the resource pool corresponding to the positioning reference signal is different from the resource pool corresponding to data transmission.

7. The method according to claim 1, wherein the determining, based on the measurement request information, the transmission resource among the candidate resources comprises:
determining a target resource among the candidate resource, wherein the target resource overlaps with the measurement slot;
when a ratio of the number of target resources to a total number of candidate resources is greater than or equal to a preset threshold, determining the target resource as the transmission resource.

8. The method according to claim 1, wherein the number of the second terminal devices is M; and the determining, based on the measurement request information, the transmission resource among the candidate resources comprises:
determining a target resource corresponding to each second terminal device among the candidate resource, wherein the target resource overlaps with the measurement slot corresponding to the second terminal device;
determining, based on the number of the target resources corresponding to each second terminal device, N target terminal devices among M second terminal devices, wherein a ratio of the number of the target resources corresponding to the target terminal device to a total number of the candidate resources is greater than or equal to a first threshold;
if a ratio of the N to the M is greater than or equal to a second threshold, determining, based on target resources corresponding to the N target terminal devices, the transmission resource.

9. The method according to claim 8, wherein the determining, based on the target resources corresponding to the N target terminal devices, the transmission resource comprises:
determining an intersection of target resources corresponding to the N target terminal devices as the transmission resource; or,
determining a union of target resources corresponding to the N target terminal devices as the transmission resource.

10. A signal transmission method, applied to a second terminal device, comprising:
sending measurement request information to a first terminal device;
receiving a positioning reference signal corresponding to the measurement request information sent by the first terminal device, wherein the positioning reference signal is used to determine a location of the second terminal device.

11. The method according to claim 10, wherein the measurement request information comprises at least one of:
a starting time domain position of a measurement slot;
a period of a measurement slot;
duration of a measurement slot.

12. The method according to claim 10, wherein the sending the measurement request information to the first terminal device comprises:
sending the measurement request information to the first terminal device in a unicast, multicast or broadcast mode.

13. The method according to claim 10, wherein the receiving the positioning reference signal corresponding to the measurement request information sent by the first terminal device comprises:
receiving the positioning reference signal through a resource in a resource pool corresponding to the positioning reference signal; or receiving the positioning reference signal through a resource in a resource pool corresponding to data transmission.

14. A signal transmission apparatus, applied to a first terminal device, comprising:
a memory, a transceiver and a processor:
wherein the memory is configured to store a computer program;
the transceiver is configured to send and receive data under control of the processor;
wherein the processor is configured to:
receive measurement request information sent by a second terminal device;
send, based on the measurement request information, a positioning reference signal to the second terminal device.

15. A signal transmission apparatus, applied to a second terminal device, comprising a memory, a transceiver and a processor;
wherein the memory is configured to store a computer program:
the transceiver is configured to send and receive data under control of the processor;
the processor executes the computer-executable instruction stored in the memory, to cause the processor to execute the data processing method according to claim 10.

16. (canceled)

17. A non-transitory computer-readable storage medium, wherein the computer-readable storage medium has a computer program stored thereon, and when the computer program is executed by a computer, the method according to claim 1 is implemented.

18. (canceled)

19. The apparatus according to claim 14, wherein the measurement request information comprises at least one of:
a starting time domain position of a measurement slot;
a period of a measurement slot;
duration of a measurement slot.

20. The apparatus according to claim 19, wherein the processor, by executing the computer program, is configured to: determine, based on the measurement request information, a transmission resource;
the transceiver is configured to send the positioning reference signal to the second terminal device on the transmission resource.

21. The apparatus according to claim 20, wherein the processor is configured to:
determine a candidate resource in a resource pool corresponding to the positioning reference signal;
determine, based on the measurement request information, the transmission resource among the candidate resource.

22. A non-transitory computer-readable storage medium, wherein the computer-readable storage medium has a computer program stored thereon, and when the computer program is executed by a computer, the method according to claim 10 is implemented.
